(19) United States
(12) Patent Application Publication
(10) Pub. No.: US 2017/0261993 A1
(43) Pub. Date: Sep. 14, 2017

(54) SYSTEMS AND METHODS FOR ROBOT MOTION CONTROL AND IMPROVED POSITIONAL ACCURACY

(71) Applicant: Xerox Corporation, Norwalk, CT (US)

(72) Inventors: Dennis L. Venable, Marion, NY (US); Wencheng Wu, Rochester, NY (US); Thomas F. Wade, Rochester, NY (US); Ethan Shen, Toronto (CA); Charles D. Rizzolo, Faiport, NY (US)

(73) Assignee: Xerox Corporation

(21) Appl. No.: 15/066,392

(22) Filed: Mar. 10, 2016

(51) Int. Cl. G05D 1/02; G06Q 10/08

(52) U.S. Cl. CPC G05D 1/0248; G06Q 10/087; Y10S 901/01; G05D 2201/0207

(57) ABSTRACT

Direction and speed of robotic data acquisition systems engaged in acquiring data in mapped or route-planned environments, and/or environments having reference features (e.g., shelves, walls, curbs or other structure) enabling additional guidance and control, are disclosed. A mobile base can include wheels adapted to navigate an environment. At least one sensor (e.g., imaging camera, acoustic, passive infrared, etc.) can be mounted on the mobile base and acquires data (e.g., images) of items associated with or located along fixed structures defining the pathways within the environment. A computer can control mobile base movement and orientation with respect to the at least one structure utilizing range sensors and PID controllers, track mobile base location, and organize acquired data. Range sensors under the control of the at least one computer can be adapted to control mobile base movement in a straight line and at a constant speed with respect to a fixed structure.

### FIELD OF THE EMBODIMENTS

The present invention is generally related to the fields of robotics and data acquisition. More particularly, the present invention is related to systems and methods providing robotic motion control and positional accuracy to a mobile platform acquiring data within an environment having pathways defined by fixed structures such as curbs, walls, or aisles.

### BACKGROUND

In the retail robotics applications, autonomous robots can traverse store flooring while performing one or more operations that involve analysis of the store shelf contents. One such operation can be to read the barcodes that are present on the shelf edges. Another operation can be to determine empty store shelves for restocking. Such operations can further include capturing high resolution images of the shelves for reading barcodes, capturing low resolution images for product identification by image analysis, or using depth information sensors such as LIDAR or Kinect to identify “gaps” in the product presentation (missing products).

In any of these missions it is imperative that the location and orientation of the robot is well known when data is captured so the analytics can identify the location of items on shelving along store aisles accurately. In the case of barcode reading, a robotic data acquisition system built and tested by the present inventors was able to take high resolution images approximately every 12 inches. For certain optics and resolutions of interest, this system allowed a horizontal overlap between successive images of about 6 inches when the navigation system led the robot to the expected location at expected orientation. In many cases a single barcode will be visible in two successive images (on the right of the first image and on the left of the second image or vice versa depending on the travel direction of the robot). If the robot's orientation is off by just one degree from what is expected, then the evaluated position of the barcode can be off by 0.5 inch. If the location of the robot down the aisle is off by an inch, then the detected barcode location will be off by an inch. If the distance to the shelf is off by 2 inches, the barcode location can be off by another 0.5 inch. Combining the errors together can easily yield an error in the evaluated barcode position of +/−2 inches or more. Barcodes are typically about 1 inch wide. If the same barcode is visible in two successive frames and the errors are significant, then the system will not be able to realize that the barcode is the same and may consider it two separate barcodes of the same kind (e.g., same UPC). This is called a product facing error (the system sees more product barcodes than it should) and causes errors in the data analytics to be performed on the captured data, such as compliance testing. In our prototype systems, this has been a frequent problem. Orientation errors have been up to 4 degrees and positional errors up to 3 inches in system tests.

Some autonomous robots deployed in retail settings can use an algorithm based on the SLAM (Simultaneous Localization and Mapping) architecture to simultaneously understand the location of the robot and update a “store map”. This allows a device to constantly update its view of the environment and enable it to handle changes in the environment. However, such an algorithm heavily relies on statistical outcomes applied to noisy sensor data and does not meet the high positional accuracies required by certain retail robotics missions. SLAM can be used in combination with an appropriate path planning algorithm to move the robot to a specified point on the store map, but there are still limits as to how accurate the robot can achieve the desired location. When used to read store shelf barcodes, an autonomous robot based on SLAM architecture generally cannot report its location and orientation to the high accuracy required for reliable analysis of the data captured. Routinely, error in orientation can be up to 4 degrees and errors in position can be up to 3 inches. These errors have prevented systems from knowing the location of the barcodes accurately enough for the data analytics to perform the required analysis. The use of higher quality sensors in the robot may potentially reduce these errors, but at a prohibitively higher cost.

Therefore, there is a need for improved systems and methods for maintaining direction and speed of robotic systems engaged in acquiring data in mapped or route-planned environments having pathways (e.g., aisles) defined by fixed objects (e.g., shelving).

### SUMMARY OF THE EMBODIMENTS

The present invention is described in the context of a solution for accurately acquiring data from shelving in a retail setting using a robotic data acquisition system; however, any reference to a retail environment, shelving, product-related data is for exemplary purposes only and refer to a particular embodiment. It should be appreciated, however, that the robotic data acquisition system described herein can also be used to acquire data in diverse environments containing fixed structures that define pathways for robot movement.

The present inventors have determined that an autonomous robot cannot reliably report its location and orientation to the high accuracy that is needed for reliable analysis of the data captured during a data gathering operation using SLAM alone. A second motion control mode is needed that can provide more accurate location information while the robot is performing data capture. Accordingly, it is a feature of the present embodiments to provide an autonomous robot control system that can maintain a desired distance and orientation to a fixed structure (e.g., a retail store shelf) at a specified speed and travel distance using: 1) range sensing, which can be from a Light Detection And Ranging (LIDAR); 2) a Proportional Integral Derivative (PID) controller to maintain a constant distance to the fixed structure; and 3) monitor high-precision wheel encoders to accurately measure distance traveled along a pathway that may be defined by the fixed structure.

### BRIEF DESCRIPTION OF THE DRAWINGS

FIG. 1 illustrates a diagram of a robotic data acquisition system in accordance with embodiments of the present invention;

FIG. 2 illustrates a block diagram for components that can be included in a robotic data acquisition system in accordance with embodiments of the present invention;

FIG. 3 illustrates a block diagram of an exemplary retail environment depicted with a travel path along the aisle where the control paradigm of the present invention can apply in accordance with embodiments of the present invention; and

FIG. 4 illustrates a block diagram of a method for acquiring data using a robotic data acquisition system in accordance with embodiments of the present invention.

### DETAILED DESCRIPTION OF PREFERRED EMBODIMENTS

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative are shown. The embodiments disclosed herein can be embodied in many different forms and should not be construed as limited to the embodiments set forth herein: rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the disclosed embodiments. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which disclosed embodiments belong. It will be further understood that terms such as those defined in commonly used dictionaries should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, system, and/or a processor-readable medium. Accordingly, the embodiments may take the form of an entire hardware application, an entire software embodiment, or an embodiment combining software and hardware aspects all generally referred to herein as a “circuit” or “module.” Furthermore, the embodiments may take the form of a computer program product on a computer-usable storage medium having computer-usable program code embodied in the medium. Any suitable computer-readable medium or processor-readable medium may be utilized including, for example, but not limited to, hard disks, USB Flash Drives, DVDs, CD-ROMs, optical storage devices, magnetic storage devices, etc.

Computer program code for carrying out operations of the disclosed embodiments may be written in an object oriented programming language (e.g., Java, C++, etc.). The computer program code, however, for carrying out operations of the disclosed embodiments may also be written in conventional procedural programming languages such as the “C” programming language, HTML, XML, etc., or in a visually oriented programming environment such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., WiFi, Wimax, 802.xx, and cellular network, or the connection may be made to an external computer via most third party supported networks (for example, through the Internet using an Internet Service Provider).

The disclosed embodiments are described in part below with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Note that the instructions described herein such as, for example, the operations/instructions and steps discussed herein, and any other processes described herein can be implemented in the context of hardware and/or software. In the context of software, such operations/instructions of the methods described herein can be implemented as, for example, computer-executable instructions such as program modules being executed by a single computer or a group of computers or other processors and processing devices. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, tablet computers (e.g., iPad and other “Pad” computing device), remote control devices, wireless hand held devices, Smartphones, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc. Additionally, the term “module” can also refer in some instances to a hardware component such as a computer chip or other hardware.

It will be understood that the circuits and other means supported by each block and combinations of blocks can be implemented by special purpose hardware, software, or firmware operating on special or general-purpose data processors, or combinations thereof. It should also be noted that, in some alternative implementations, the operations noted in the blocks might occur out of the order noted in the figures. For example, two blocks shown in succession may in fact be executed substantially concurrently; the blocks may sometimes be executed in the reverse order; the varying embodiments described herein can be combined with one another: or portions of such embodiments can be combined with portions of other embodiments in another embodiment.

Due to the prevalence of surveillance cameras and the increasing interest in data-driven decision-making for operational excellence, several technical initiatives are currently focused on developing methods of collecting/extracting image-based and/or video-based analytics. In particular, but without limiting the applicable scope of the present invention, there is a desire by industry to bring new image-based and video-based technologies into retail business settings. An example is wherein image- and video-based technologies are being used that include store shelf-product imaging and identification, spatial product layout characterization, barcode and SKU recognition, auxiliary product information extraction, and panoramic imaging of retail environments.

Without unnecessarily limiting the scope of the present invention to retail uses, there are, for example, a large number of retail chains worldwide and across various market segments, including pharmacy, grocery, home improvement, and others. Functions that many such chains have in common are sale advertising and merchandising. An element within these processes is the printing and posting of sale item signage within each store, which very often occurs at a weekly cadence. It would be advantageous to each store if this signage was printed and packed in the order in which a person encounters sale products while walking down each aisle. Doing so eliminates a non-value-add step of manually having to pre-sort the signage into the specific order appropriate for a given store. Unfortunately, with few current exceptions, retail chains cannot control or predict the product locations across each of their stores. This may be due to a number of factors: store manager discretion, local product merchandising campaigns, different store layouts, etc. Thus it would be advantageous to a retail chain to be able to collect product location data (which can also be referred to as a store profile) automatically across its stores, since each store could then receive signage in an appropriate order to avoid a pre-sorting step.

There is growing interest by retail enterprises in having systems that use image acquisition for accelerating the process of determining the spatial layout of products in a store using printed tag information recognition. Although “barcodes” will be described as the tag information for purposes of the rest of this disclosure, it should be appreciated that imaging could equally apply to other patterns (e.g., such as QR codes) and serial numbers (e.g., such as UPC codes). Furthermore, the solutions disclosed herein can apply to several environments including retail, warehouse, and manufacturing applications, where identifying barcoded item location is desired. The invention described herein addresses a critical failure mode of such a system. In particular, the present invention is generally described, without suggesting any limitation of its applicability, with an embodiment aimed at eliminating or reducing the errors in determining the location of detected barcodes along the length of the aisle to improve the accuracy of the store profile and any analysis performed on the barcode data.

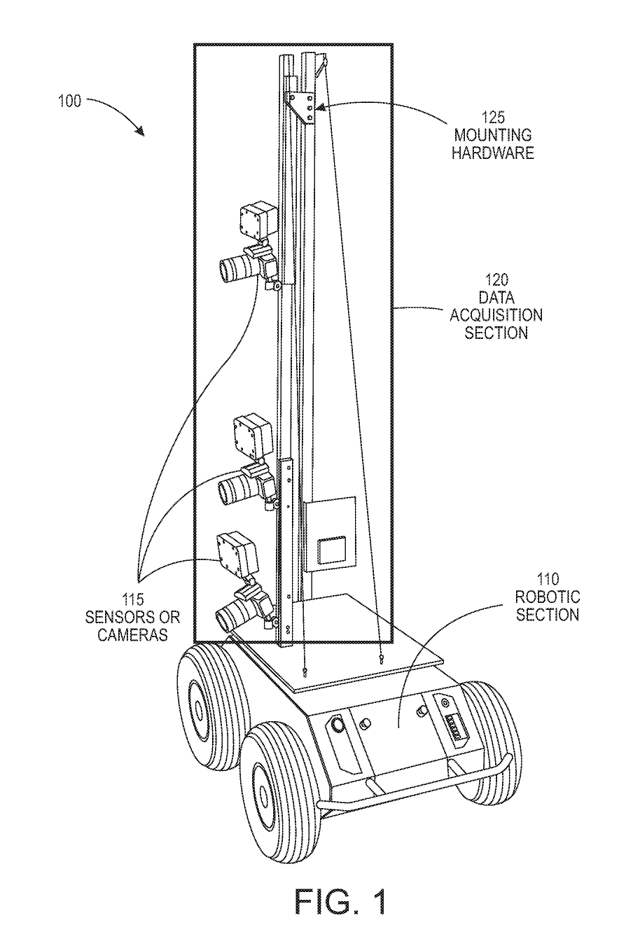

FIG. 1 illustrates a diagram of a robotic data acquisition system 100 in accordance with features of the embodiments. The prototyped system 100 is shown for exemplary purposes and not meant to limit the scope, style, or design of the present invention. The system 100 can provide improved control and management of system direction and speed. The system 100 is robotically controlled by a robotic section 110 and includes a data acquisition section 120. For exemplary purposes only, the data acquisition section 120 as shown in the photograph includes, without limitation, multi-camera imaging hardware 115. It should be appreciated that the data acquisition section 120 can include various means of acquiring data including cameras and sensors. At least one sensor (e.g., imaging camera, acoustic, passive infrared, etc.) can be mounted onto the mobile base to acquire data (e.g., images) of items associated with or located along at least one structure further defining the pathways within the environment. Mounting hardware 125, as depicted in the photograph, can include a post or rail onto which data acquisition equipment is mounted. A robotic system similar to the robotic data acquisition system 100 as shown has been proven by the present inventors to be suitable for acquiring data in the form of images of product sitting on store shelves up to 7′ tall. For taller shelf units in this example retail application, more cameras could be used.

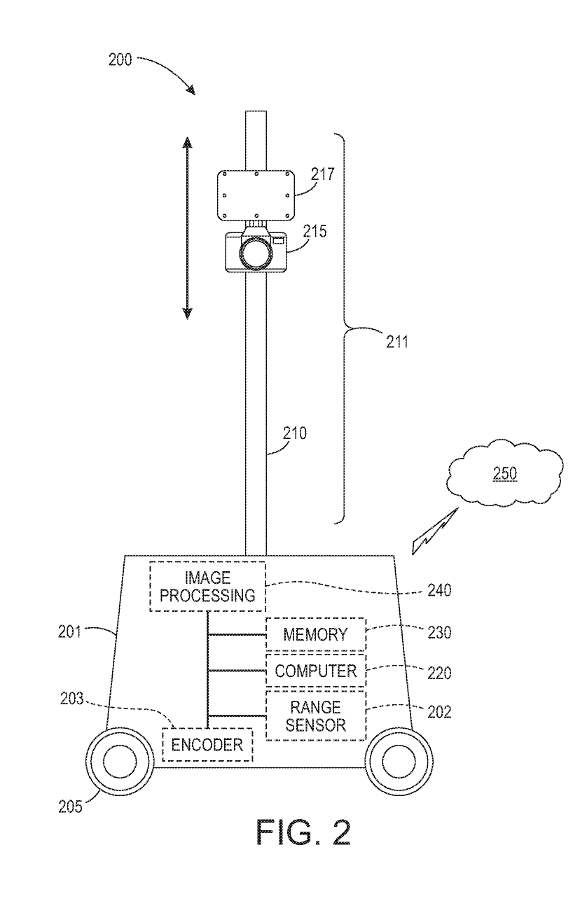

Referring to FIG. 2, a block diagram of a robotic data acquisition system 200 in accordance with features of the present invention is illustrated. This embodiment is again taught in the context of a retail setting for exemplary purposes only, but as stated hereinbefore this should not be taken as a limitation with respect to its scope or application. This robotic data acquisition system 200 includes a robotic section 201, which further includes wheels 205 for facilitating movement of the system 200 along the ground (e.g., flooring) within a defined (e.g., planned) environment. At least one range sensor 202 can be associated with the robotic section 201 and can measure distance to physical structures, such as curbs, walls, or aisles, along which the robotic data acquisition system 200 can move along as it acquires data using a data acquisition section 211. The range sensor 202 can be provided in the form of a Light Detection And Ranging (LIDAR). The robotic section 201 can also include a Proportional Integral Derivative (PID) controller. The range sensor 201 and the PID (Proportional-Integral-Differential) controller can be under operational control of at least one computer 220 to maintain a constant distance relative to a data acquisition target as the robotic data acquisition system 200 is moved horizontally. The PID controller can be implemented as a software component within the computer 220. The robotic section 201 can also include a motor controller that can control the speed and direction of the wheels 205. The motor controller can also be under operation control of the computer 220. The robotic section 201 can also include at least one wheel encoder 203 associated with at least one of the wheels 205 and under operational control of the at least one computer 220 to accurately monitor at least one of speed and distance traveled. A PID controller can be used to adjust motor speeds to maintain shelf distance. The PID can be adjusted such that robot motion travels smoothly with no large changes in angle to the shelf and no sharp orientation adjustments or speed changes.

As stated before, the data acquisition section 211 can include systems such as cameras or sensors required to acquire the targeted data. In FIG. 2, a camera 215 with an illuminator 217 is shown, but this is for exemplary purposes only. It should be appreciated that any variety or number of cameras and sensors could be mounted to the mounting hardware 210 supported by the robotic section 201. The data gathering equipment can also be in communication with data processing, such as an image-processing module 240 and can access a memory 230 and computer 220 that can be contained within the robotic section 201. The data acquisition equipment could also be self-contained and not dependent on system module associated with or housed by the robotic section 201. The data acquisition system can include wireless communication with a data network 250, through which it can receive commands, direction, and/or share or transmit data for remote analysis.

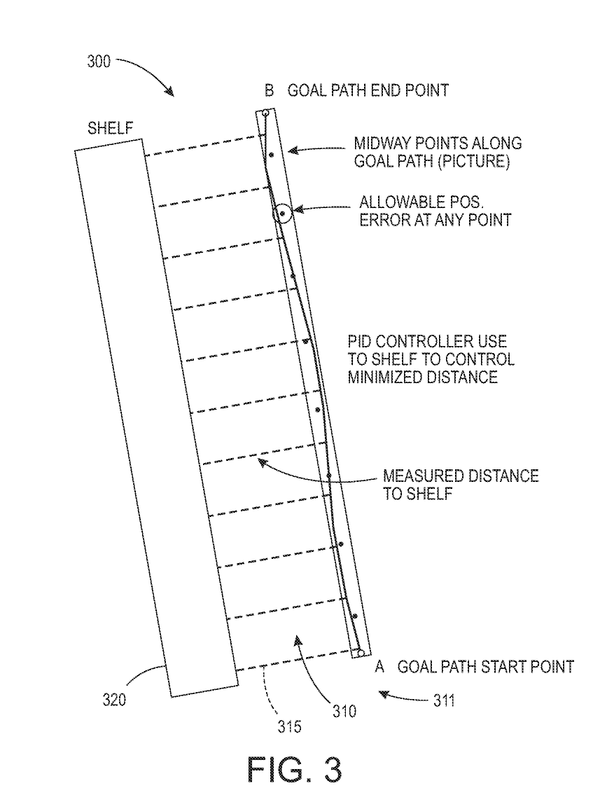

Referring to FIG. 3, an environment 300 is depicted with a travel path shown from A to B along the aisle 310 where aspects of the present invention can be deployed. The range sensor 202 is used to measure distance 315 of a robotic data acquisition system 200 to and along a structure such as a shelf 320. Range sensor 202 can also be used to measure the orientation of the robotic data acquisition system 200 with respect to the shelf. The motor controller can be used to control the speed and direction that the robotic data acquisition system 200 travels along the aisle 310. The PID controller can takes as input the distance to the shelf 320 as measured by the range sensor 202 and can calculate how the speed and direction of the robotic data acquisition system 200 should change to maintain travel and data acquisition accuracy. The PID controller can also take as input the orientation of the robot with respect to the shelf 320 as measured by the range sensor 202. Computer 220 can take the output of the PID controller and generate the appropriate inputs to the motor controller to adjust the speed and direction that the robotic data acquisition system 200 should follow along path A to B and defined by aisle 310. The PID controller can be adjusted such that robot motion stays smooth with no large changes in angle with respect to the shelf 320 and without sharp orientation adjustments or speed changes. These control features help the robotic data acquisition system 200 to achieve minimal errors in travel and data acquisition (i.e., by keeping the robotic data acquisition system 200 moving parallel to the structure 320). During testing of the prototype 100, features of the present embodiments have shown significant reduction in orientation errors (down to a fraction of a degree) over 8 foot runs. Similarly, the error in distance 315 to, for example, a shelf 320 were reduced to less than an inch, and errors along the travel direction were kept to less than ½ inch.

In the prototype as tested, the robotic data acquisition system 200 moved to the beginning of the aisle 311 using an API called MoveTo(x,y,orientation) that utilizes standard motion commands (based on SLAM) to safely navigate around store obstacles to get to the desired point. However, once the robot arrives at the beginning of the aisle 311, a different API called TravelPath( . . . ) can be invoked. This method implements the control paradigm described herein. Accurate positional understanding is an enabler for the data analytics applied to barcode data as well as gap identification from LIDAR measures. The robot simply has to know where it is for any collected data to make sense.

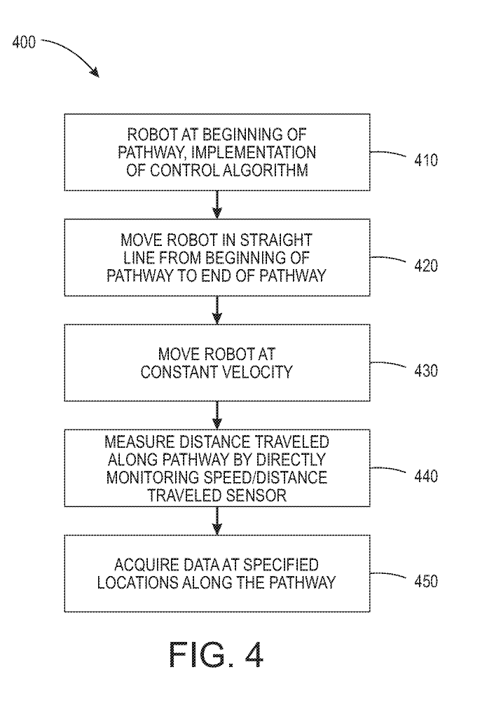

Referring to FIG. 4, a block diagram 400 of a method is illustrated, in accordance with the embodiments. In accordance with a retail environment examples provided in parenthesis, and without limitation of the present embodiments to such an application, the SLAM-based navigation ability has been found useful for the robot to successfully move around an environment (e.g., a store or retail establishment with shelving) and maintain its location with respect to structures within the environment (e.g., aisles deployed on a the store map), since the robot has to navigate the entire environment. Once the robot has gotten to the beginning of a pathway (e.g., beginning of aisle 311) as shown in block 410, a control algorithm can be implemented that:
1) Moves the robot in a straight line from the beginning of the pathway to the end of the pathway, as shown in block 420.
2) Moves at a constant velocity, as shown in block 430.
   a. This step can include continuously modifying the wheel speed to keep the robot at a fixed distance from the shelf. The distance to the shelf and angle to the shelf can be calculated from the same LIDAR 202 data used by SLAM. Alternatively, a laser rangefinder, Kinect, or other range sensor could be used to measure the distance to the shelf. A PID controller can be used to adjust motor speeds to maintain shelf distance. The PID can be adjusted such that robot motion stays smooth with no large changes in angle to the shelf and no sharp orientation adjustments or speed changes.

The method continues with the steps of:
3) Accurately measure the distance traveled along the straight line by directly monitoring speed/distance-traveled sensors (e.g., the robot's wheel encoders 203), as shown in block 440. This action does not participate in the PID control, but is critical in accurately measuring the distance travelled down the aisle 311 to know when image data is to be acquired (e.g., a picture is taken).
4) Then the system can acquire data (e.g., by taking pictures) at specified locations along the pathway (e.g., aisle) as measured by step 3 above, as shown in block 450.

Once the robot has come to the end of the aisle, SLAM-based navigation is used to safely move to the beginning of the next aisle, where the above control loop above is repeated. This continues until the store is completely scanned.

Since this embodiment monitors wheel motion along, for example, the aisle and the PID controller minimizes angle and distance errors, the location of the robot along the aisle is known to the accuracy of the wheel encoders when the camera pictures are taken. Therefore, if barcodes are detected within the images, the location of the barcodes along the aisle can be determined to the accuracy of the wheel encoders and the measured angle-to-the-shelf and distance-to-shelf.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A system for navigating a robotic data acquisition system with respect to an environment, comprising:
a mobile base including wheels and adapted to navigate throughout the environment;
a motor controller capable of controlling at least one wheel of the wheels included with the mobile base, and thereby also capable of controlling the speed and direction of the robotic data acquisition system;
at least one computer and a memory, said computer adapted by a program stored in the memory to control movement of the mobile base;
a distance traveled sensor including an encoder associated with at least one wheel of the wheels, said encoder under control of the at least one computer for accurately monitoring distance traveled by the mobile base;
a range sensor under control of the at least one computer for accurately measuring distance of the mobile base from fixed structures located in the environment and for measuring orientation of the mobile base to the fixed structures; and
a PID controller maintaining a constant distance of the system to the fixed structures;
wherein the at least one computer is further adapted to control mobile base movement along a defined pathway and at a constant speed with respect to distance of the mobile base relative to the fixed structures.

2. The system of claim 1, wherein said distance traveled sensor comprises at least one high resolution wheel encoder coupled to a wheel and the range sensor further comprises a Light Detection And Ranging (LIDAR), wherein the high resolution wheel encoder, LIDAR, and PID controller are under operational control of the at least one computer to maintain a constant distance and orientation relative to a data acquisition target and to monitor wheel encoders to accurately measure a distance traveled.

3. The system of claim 1, further comprising a data acuisition section mounted on said mobile base and including at least one of a camera or a sensor, said data acquisition section for acquiring data in association with the environment or the at least one structure further defining the defined pathways within the environment.

4. The system of claim 3, wherein said distance traveled sensor comprises at least one high resolution wheel encoder coupled to a wheel, wherein the range sensor, PID controller, and motor controller are under operational control of the at least one computer to maintain a constant distance and orientation relative to a data acquisition target and to monitor wheel encoders to accurately measure travel distance.

5. The system of claim 4, further comprising a data acuisition section mounted on said mobile base and including at least one of a camera or a sensor, said data acquisition section for acquiring data in association with the environment or the least one structure further defining the defined pathways within the environment.

6. The system of claim 1, further comprising a data acuisition section mounted on said mobile base and including at least one of a camera, wherein the environment is a retail establishment and the defined pathway is defined by the structures provided in the form of aisle shelving, wherein said at least one camera acquires images of product contained on the shelving.

7. The system of claim 6, wherein said distance traveled sensor comprises at least one high resolution wheel encoder coupled to a wheel and wherein the range sensor further comprises a Light Detection And Ranging (LIDAR), wherein the range sensor, PID controller, and motor controller are under operational control of the at least one computer to maintain a constant distance and orientation of the robotic data acquisition system relative to the shelving and to monitor wheel encoders to accurately measure travel distance.

8. The system of claim 3, further comprising a computer program implementing a control algorithm to move the robotic data acquisition system in a straight line from a beginning of a pathway to an end of the pathway, and move at a controlled velocity along the pathway.

9. The system of claim 8, wherein the computer program under control of the microprocessor continually modifies wheel speed and distance of the robotic system the at least one fixed structure to keep the robotic data acquisition system at a fixed distance from the at least one fixed structure while traveling at a constant speed.

10. The system of claim 9, wherein the computer program further controls the at least one camera or sensor of the data acquisition section to acquire data in association with the environment or the least one structure further defining the pathway while the robotic data acquisition system moves along the pathway.

11. A system for navigating a robotic data acquisition system with respect to an environment including pathways defined by fixed structures located in the environment, comprising:
a mobile base including wheels and adapted to navigate throughout the environment;
at least one computer and a memory contained in the mobile base, said computer adapted by a program stored in the memory to control movement of the mobile base;
a motor controller under control of the at least one computer and capable of controlling at least one wheel of the wheels included with the mobile base, and thereby also capable of controlling the speed and direction of the robotic data acquisition system along the pathways defined by the fixed structures;
a distance traveled sensor including an encoder associated with at least one wheel of the wheels, said encoder under control of the at least one computer for accurately monitoring distance traveled by the mobile base along pathways defined by the fixed structures;
a range sensor further comprising a Light Detection And Ranging (LIDAR) under control of the at least one computer for measuring distance of the mobile base from the fixed structures and for measuring orientation of the mobile base to the fixed structures;
a PID controller under control of the at least one computer for maintaining a constant distance of the system to the fixed structures based on input from the range sensor, wherein the constant distance and movement of the mobile base along the pathways at a constant speed with respect to distance of the mobile base relative to the fixed structures is facilitated by the motor controller under operational control of the at least one computer; and
a data acquisition section mounted on said mobile base and including at least one camera or sensor for acquiring images of at least one of the fixed structures or articles associated with the fixed structures as the mobile base moves along the pathways.

12. The system of claim 11, further comprising a computer program implementing a control algorithm to move the robotic data acquisition system in a straight line from a beginning of a pathway to an end of the pathway, and move at a constant velocity along the pathway.

13. The system of claim 12, wherein the environment is a retail establishment, the fixed structures are shelving, and the pathways are aisles defined by the shelving, and wherein data acquired by the robotic data acquisition system includes images of facing information for product associated with the shelving as images are acquired by the at least one camera and input into the computer to generate plane-like panoramas representing inventory, inventory location, and a layout of the retail environment.

14. The system of claim 13, wherein said images of each aisle are processed and organized based on aisle location within the retail establishment, shelving location within aisles, product carried on shelving, and said images ordered for shelf-product layout identification and planogram compliance.

15. The system of claim 12, wherein the computer program under control of the microprocessor continually modifies wheel speed and distance of the robotic system from at least one fixed structure to keep the robotic data acquisition system at a fixed distance from the at least one fixed structure while traveling at a controlled speed.

16. The system of claim 15, wherein the computer program further controls the at least one camera or sensor of the data acquisition section to acquire data in association with the environment or the least one structure further defining the pathway while the robotic data acquisition system moves along the pathway.

17. A method of obtaining data from environments including pathways defined by fixed structures, comprising:
provide a robotic system further comprising a data acquisition section including at least one of a camera or sensor, and a robotic section including wheels supporting the data acquisition section, said robotic section further including a computer, a memory, at least one range detector, and a PID controller configured to determine and maintain a distance of the mobile base away from the fixed structure and with respect to the fixed structures, motor controller, and a wheel decoder to control wheel movement and speed and movement of the mobile base thereby along the pathways and to monitor a distance traveled by the mobile base on the pathways, and said motor control under the control of the computer to navigate the mobile base at controlled speeds along the pathways and range in distance with respect to structure deployed throughout the environment;
a computer program stored in the memory and processed by the computer to implement a control algorithm for carrying out the steps of:
positioning the robotic data acquisition system at a beginning of a pathway;
measuring the range in distance of the mobile base with respect to a fixed structure defining the pathway while moving the robotic data acquisition system in a straight line with respect to the fixed structure from beginning of pathway to an end of pathway;
moving the robotic data acquisition system at a controlled velocity and orientation along the pathway;
continuously measuring a distance of travel of the robotic data acquisition system along the pathway by monitoring the wheel encoder and range detector; and
acquiring data from at least one of the fixed structures at specified locations along the pathway.

18. The method of claim 17, wherein the environment is a retail establishment, the pathways are aisle defined by shelving, and data acquisition includes images of articles on aisle shelving captured by a camera, organized to establish shelf product location, and identify a layout of a retail establishment.

19. The method of claim 17, wherein the range sensor is at least one of a Light Detection And Ranging (LIDAR) and a Proportional Integral Derivative (PID) controller under operational control of at least one computer associated with the robotic system to maintain a constant distance and orientation relative to at least one of the structure deployed throughout the environment and a data acquisition target.

20. The method of claim 17, wherein the at least one sensor to control speed of the mobile base and distance traveled by the mobile base is at least one wheel encoder associated with at least one wheel and under operational control of at least one computer associated with the robotic system to navigate the mobile base at controlled speeds and distance with respect to at least one of the structures deployed throughout the environment and a target for data acquisition.
